(19) United States
(12) Patent Application Publication
(10) Pub. No.: US 2008/0022632 A1
(43) Pub. Date: Jan. 31, 2008

(54) METHOD AND APPARATUS FOR MANUFACTURING OBJECTS PROVIDED WITH A SEALED SEAM

(75) Inventors: Peter Gysi, Bellikon (CH); Marcel Oberholzer, Kindhausen (CH)

Correspondence Address: MCCORMICK, PAULDING & HUBER LLP, CITY PLACE II, 185 ASYLUM STREET, HARTFORD, CT, 06103, US

(73) Assignee: Soudronic AG, Bergdietikon (CH)

(21) Appl. No.: 11/782,010

(22) Filed: Jul. 24, 2007

(30) Foreign Application Priority Data
Jul. 27, 2006 (CH) 1221/06

(51) Int. Cl. B65B 51/10; G06K 9/00

(52) U.S. Cl. 53/377.7; 382/141

(57) ABSTRACT

A method and an apparatus are provided for taking heat images of heat sealed seams. Such seams are made in heat sealing stations and in particular when making covers or lids, respectively, for containers, being provided with a tear-off foil that closes the container up to the first use of its contents. For ascertaining the air-tightness of the heat sealed seam during manufacturing a heat image of the seam is taken while the seam is still hot. By evaluating the image it can be detected whether the temperature of the seam is within a range that assures a correct seam or has exceeded an upper or lower limit for the temperature which is indicative of a defective heat sealed seam. Defective objects can then be discarded based on the evaluation of the heat image. This test of the correctness of the heat sealing is much faster than a pressure differential test testing the actual air tightness of the seam and can thus be used in high speed manufacturing apparatus for covers or lids, respectively.

### CROSS REFERENCE TO RELATED APPLICATIONS

This application claims the priority of Swiss patent application 1221/06, filed Jul. 27, 2006, the disclosure of which is incorporated herein by reference in its entirety.

### BACKGROUND OF THE INVENTION

The invention relates to a method for the manufacture of a sequence of objects with a sealed seam and in particular a sequence of lids or covers, respectively, each provided with a tear off foil connected to the lid or cover, respectively, by said sealed seam. The invention further relates to an apparatus for manufacturing a sequence of objects with a sealed seam and in particular of a sequence of lids or covers, respectively, each provided with a tear off foil.

### PRIOR ART

Covers or lids, respectively, made of metal and provided on packages and mainly on containers in the form of cans or boxes, respectively, are known as covers or lids being permanently fixed to the container and being provided with an opening in said cover or lid, respectively. Said opening is closed and sealed by a tear-off foil, and in particular a tear-off metal foil, up to the first use of the contents of the package. The foil is fixed to the cover or lid by a sealed seam or heat-sealed joint, respectively. An additional plastic cover that is arranged over the metal cover or lid, respectively, provides a reclosure for the package during the consumption time of the contents of the package. Known methods and apparatus for making such covers or lids, respectively, are shown in prior art FIGS. 1 and 9, respectively. FIGS. 2 to 8 show the result of manufacturing steps during manufacture of such covers or lids, respectively. FIG. 1 shows a schematic side view of an apparatus 1 which is provided with several working stations 3 to 9 arranged on a machine frame 2. A conveyor 10, 13, 14 conveys objects in conveying direction shown by arrow C from the starting point at the staple 11 to the end of the apparatus where the objects move by chutes into trays 16 or 17. The objects are taken from the staple 11 in a known manner and enter into the conveyor. A known conveyor is provided with two long rails 10 each arranged on one side of the objects. By lifting the rails 10 in direction A by a crank drive 14, the objects lying on rests 10′ within the work stations 3 to 9 and, as the case may be, in rests 10′ between the work stations are lifted and are then displaced by an amount in forward direction shown by arrow B (directed in same direction as arrow C) by a crank drive 13 acting on the rails and moving the rails in forward direction B. The rails are then moved downwards in direction of arrow A and the objects are again placed on the rests. The rails 10 are then moved below the rests and in backward direction of arrow B and thus in opposite direction to arrow C and then make the same conveying movement again. Between the conveying movements the objects lie on the rests in the working stations and in rests there between and the objects are stationary within the working stations and are worked upon therein. After all work stations have finished their working operation another transport cycle moving the objects one rest position ahead by means of the rails takes place. FIG. 2 shows stapled metal blanks 20 as an example for the objects of the staple 11. Only a sector of each disk-shaped blank is shown in FIG. 2 and as well in the following FIGS. to simplify the drawings. These blanks are for example round metal disks. As an example their diameter is 11 centimeters. Other basic shapes are of course possible, such as square or rectangular shapes. Of course other diameters can be selected. The blanks have already been preformed at their edges as shown in FIG. 2 by means of another machine as is well known to the man skilled in the art. In the first working station 3 of FIG. 1 the blanks are worked upon with an upper and a lower die to punch an opening into the disk, as can be seen in FIG. 2 in which the edge of the opening is referenced as 21 and the punched out round plate is shown as 27. This plate is moved as scrap into bin 12 of FIG. 1. The punching working station 3 is operated by a drive 15 as it is the case as well for the following working stations. In working station 4 the edge 21 is drawn downwardly resulting in the shape 22 of the edge shown in FIG. 3. The ring shaped blank 20 is then conveyed into working station 5 wherein a tear-off foil 25 is placed over the opening of blank or cover 20, respectively, and is fixed to the surface of the cover by heat sealing, as can by seen in FIGS. 5 and 6. The underside of the metal foil is provided to this end in known manner with a plastic layer suitable for heat-sealing. The round foil cut that is needed is usually punched out within station 5 from a sheet of foil and placed over the opening of the annular disk. In the heat sealing station 5 the foil is pressed to the edge of the round opening of part 20 and heat is used, so that the foil 25 is fixed and sealed to the cover 20 by melting and then cooling down of the plastic layer. This is known to the person skilled in the art and is not explained in greater detail. A cooling station 7 may be provided for cooling down of the plastic layer. In working station 8 an embossing step will provide the foil 25 with an embossment 24 (FIG. 7) and the edge 22 will beaded to form the finished edge 23. The finished covers or lids 20, respectively, are tested in a testing station 9. This testing comprises usually a test of air tightness for the tear-off foil 25 fixed to the cover by the application of a pressure difference to the underside and upper side of the cover or lid, respectively. If the foil is fixed to the metal ring in an airtight manner the cover or lid, respectively, is conveyed to the bin 16 for the finished covers. If the tested cover is not airtight it will be moved over the shown chute into scrap bin 17.

FIG. 9 shows in perspective view another apparatus known from WO 2006/017953 with a conveying means with two toothed belts 31 and 32, which lie with their surfaces within the same plane and thus run coplanar to each other and are led at the start and the end of the conveying path over deflection rollers 34, 36 so that an endless toothed belt drive of the length necessary for the number of working stations is provided. The stepping movement of the belt drive in synchronism with the working stations is provided by a stepping motor or a servo drive, respectively, driving the belts by toothed rollers, as can be seen in FIG. 9 by motor 33 and drive shaft 38. If additional conveying means are provided for a parallel additional cover making apparatus, as shown by conveying means 30′, their toothed belts can be driven by the same motor by additional drive shafts or these toothed belts can be driven by their own drive. The motor 33 is controlled by a controller 37 for the stepwise advancing of the belts. This controller 37 may be a controller for the entire cover making apparatus, controlling as well the working stations, or may be a controller for the conveying means only that is communicating with a master controller for the cover making apparatus. The conveying means 30 is adapted for conveying of cover-shaped objects of the described type and serves for the stepwise movement of the objects to the working stations which are preferably the working stations for making covers as described before. These working stations are not shown in FIG. 9 but it is obvious for the person skilled in the art how to arrange such working stations along the conveying path for the necessary working of the covers. By the conveying means 30 of FIG. 9 it is possible to convey the objects or covers, respectively, between working stations with a high number of cycles, for example with 200 objects per minute, and with reproducible steps.

With a manufacturing cycle of 200 objects per minute only a very short time is available for the quality test by testing the air-tightness with a pressure difference.

### BRIEF SUMMARY OF THE INVENTION

It is an object of the present invention to provide a method and an apparatus to overcome this drawback.

Now, in order to implement these and still further objects of the invention, which will become more readily apparent as the description proceeds, the method of making objects, and in particular covers or lids, respectively, which are provided with a tear-off foil attached by heat-sealing during manufacturing of the object within a heat-sealing station comprises the steps of taking a thermographic image or heat image, respectively, within the sealing station or within a neighbouring station following said sealing station, and analysing said image.

The object is met as well by an apparatus for making objects with heat-sealed seams, and in particular covers or lids, respectively, with a tear-off foil, said apparatus comprising a conveying means for said objects and a plurality of working stations arranged along the conveying path including a heat-sealing station and comprising a device for taking a thermographic or heat image, respectively, of said object at said sealing station or at a working station downstream of said heat sealing station.

By thermographically viewing the sealed seam, which is still hot, at or in the sealing station or at or in a following station and by analysing said viewed image or picture, respectively, and thus analysing the temperature around the seam, it can be detected in a simple and swift manner whether the seam has been sealed correctly and thus whether the seam is tight. Accordingly, a time consuming pressure test can be omitted. A seam that has been correctly sealed exhibits an essentially unitary temperature along its length, which leads to a corresponding heat picture or image, respectively. Parts of the seam that have become too hot during sealing or parts of the seam that have not been heated enough look differently in said image or picture, respectively, compared to the parts or sections of the seam treated with correct temperature in said sealing station and thus exhibiting an essentially uniform temperature in the image. Accordingly, the parts or sections with a temperature too high or with a temperature that is too low can be detected as parts or sections of the seam that are potentially defective and not tight and the object can be discarded.

The viewing of the seam to form the image, be it in the form of a picture of the seam or by recording the temperature gradient, is preferably done within the sealing station and is preferably done right after the sealing tool has been opened after the sealing has been done. Light guides and in particular optical fibres arranged above and along the seam may be provided for receiving and taking up heat radiation by the seam. Their ends can be bundled together and recorded by an infrared sensitive camera, so that a single heat picture or image, respectively, of the seam is provided. Another embodiment will take several pictures or images, respectively, each of a part of said seam. In another embodiment several infrared sensitive sensors or thermometers can be arranged so that they view a temperature image of the sealed seam by recording a temperature graph along the seam. In yet another embodiment a heat picture or image, respectively, is taken by optical fibres that are led directly through the sealing disc toward the seam.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 is a schematic side view of a prior art apparatus;

FIG. 2 to 8 show sectors of metal blanks and covers for explaining their manufacture;

FIG. 9 is another prior art apparatus;

FIG. 10 is a first embodiment according to the invention of a sealing station of the apparatus for making the objects;

FIG. 11 is a partial view of the sealing station of FIG. 10;

FIG. 12 is a schematic view of the guiding of the optical fibres;

FIG. 13 is another embodiment of a sealing station; and

FIG. 14 is yet another embodiment of a sealing station.

### DETAILED DESCRIPTION OF THE INVENTION

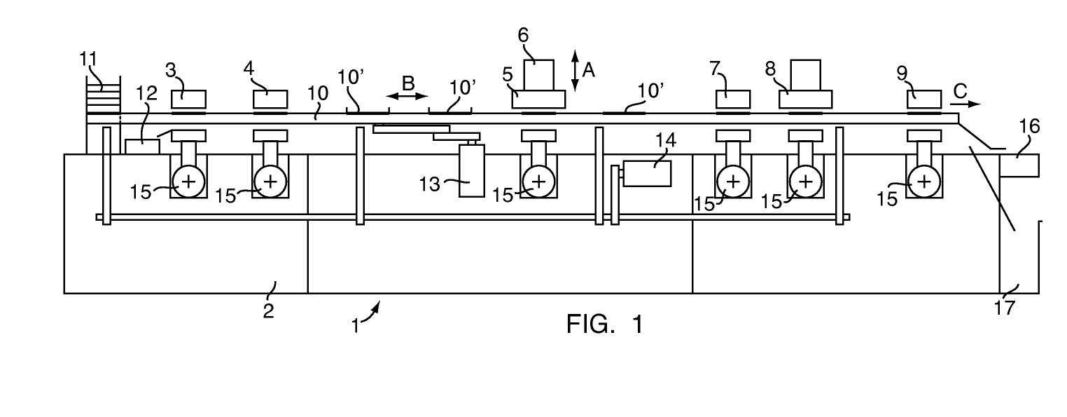

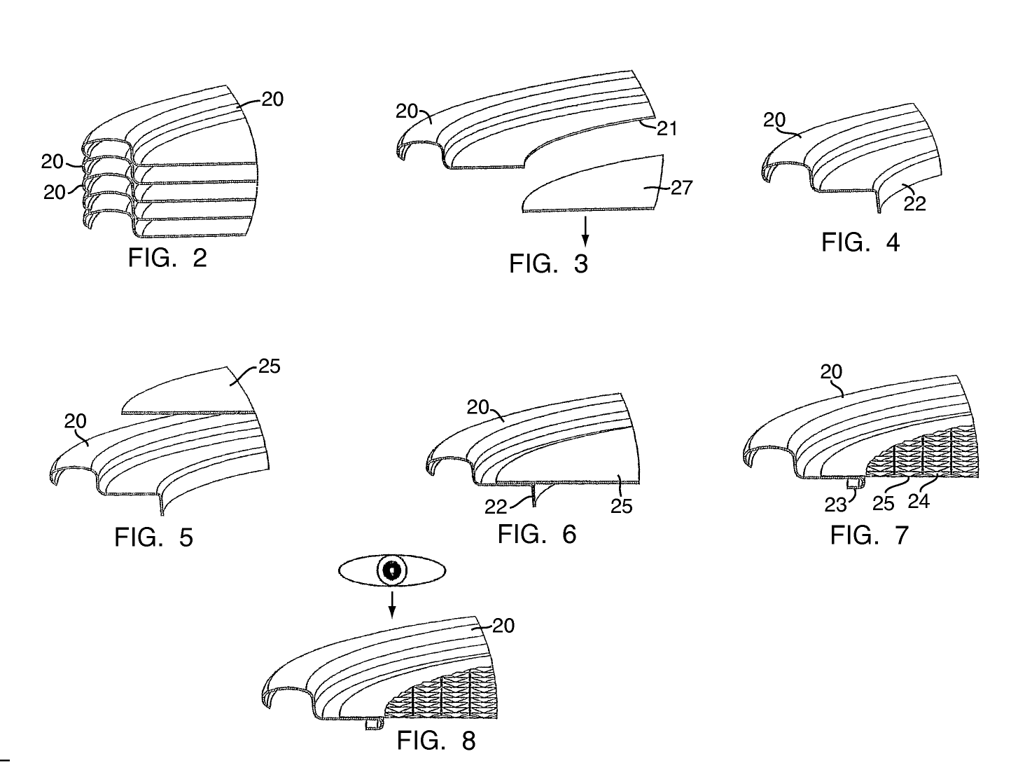

It is referred again to the description already given above in connection with the prior art and FIGS. 1 to 9 for the making of can lids with tear-off foils. The present invention is now described as well with regard to the making of lids or covers with tear-off foils, respectively, for can-like containers. But it can be used for other containers or objects with hot-sealed seams as well.

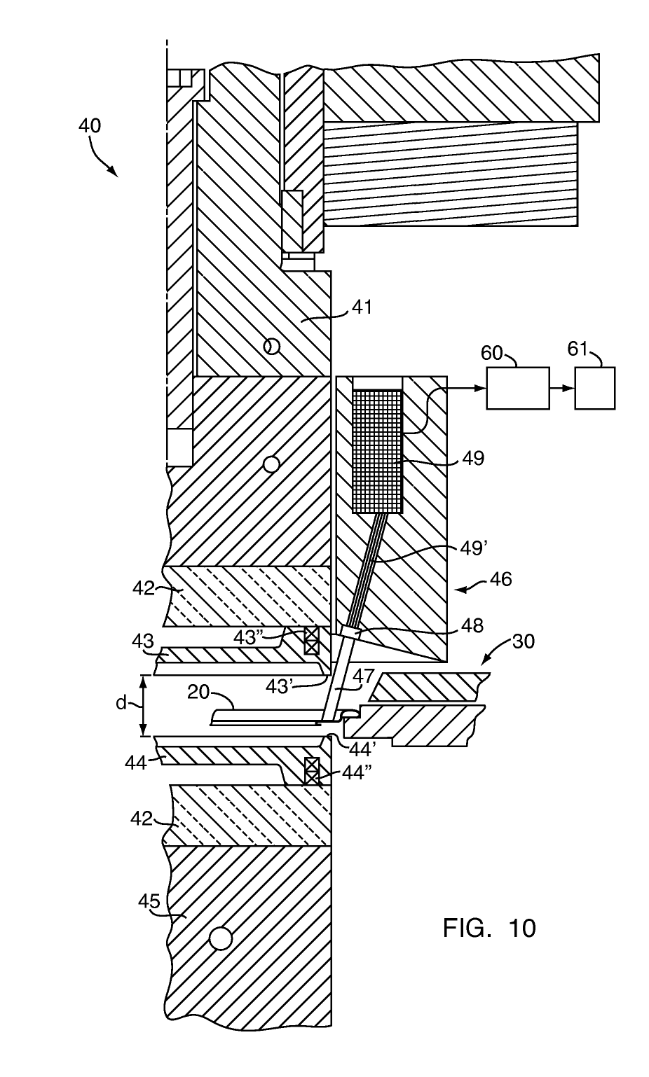

FIGS. 10 to 12 show a first embodiment of a hot sealing station 40 which is used according to the present invention for making objects and in particular lids or covers 20, respectively, with a hot sealed seam. In the hot sealing station a tear-off foil is sealingly fixed to an annular lid or cover, respectively. The tear-off foil can be a multilayer foil comprising plastic layers and one or several aluminium layers. For example it may comprise a layer of polypropylene (PP) on the side facing the cover or lid, which is covered by a layer of PET (polyethylene terephthalate) followed by a layer of aluminium which is topped by another PET-layer to form the upper surface of the tear-off foil. A printing may be arranged below said last PET-layer. A further example may comprise a layer of a hot sealing lacquer facing the cover or lid and thus the contents of the can, followed by an aluminium layer and the top layer made of PET. Further examples are known to the person skilled in the art and can be used as well. Multilayer foils need usually their correct sealing temperature range prescribed by the foil manufacturer. If the temperature is too high a delamination may occur which is as well possible if the temperature difference between the upper sealing disk and the lower sealing disc is too high. It is further known that a sealing temperature that is too low may lead to a fixation of the tear-off foil on the cover or lid that is not airtight. According to the invention a thermal or heat view, respectively, is taken of the object at or within the sealing station or in a following station as long as the hot sealed seam is still hot as a result of the sealing process. Incorrectly sealed and thus faulty areas of the seam can be detected on such a thermographic image since these areas of the seam are too hot or too cold in comparison with the correctly sealed areas of the seam. The thermographic or heat image or picture, respectively, is taken or viewed in the sealing station where the sealing is performed. A presealing station may be present which provides a first fixing of the tear-off foil but does not finish the seam. It is not intended to provide a thermal view at this presealing station. Instead of taking an image or picture or viewing the seal in the sealing station such a step may occur in a station that follows downstream of the the sealing station, preferably in a station that follows directly to the sealing station. This station must be reached by the object while the temperature of the seam is still high enough so that a meaningful thermal view can be taken. And this station must be reached so fast that the temperature difference between defective areas and correctly sealed areas is still great enough to be analysed in the thermographic view. For these reasons it is preferred to view the seam directly in the sealing station.

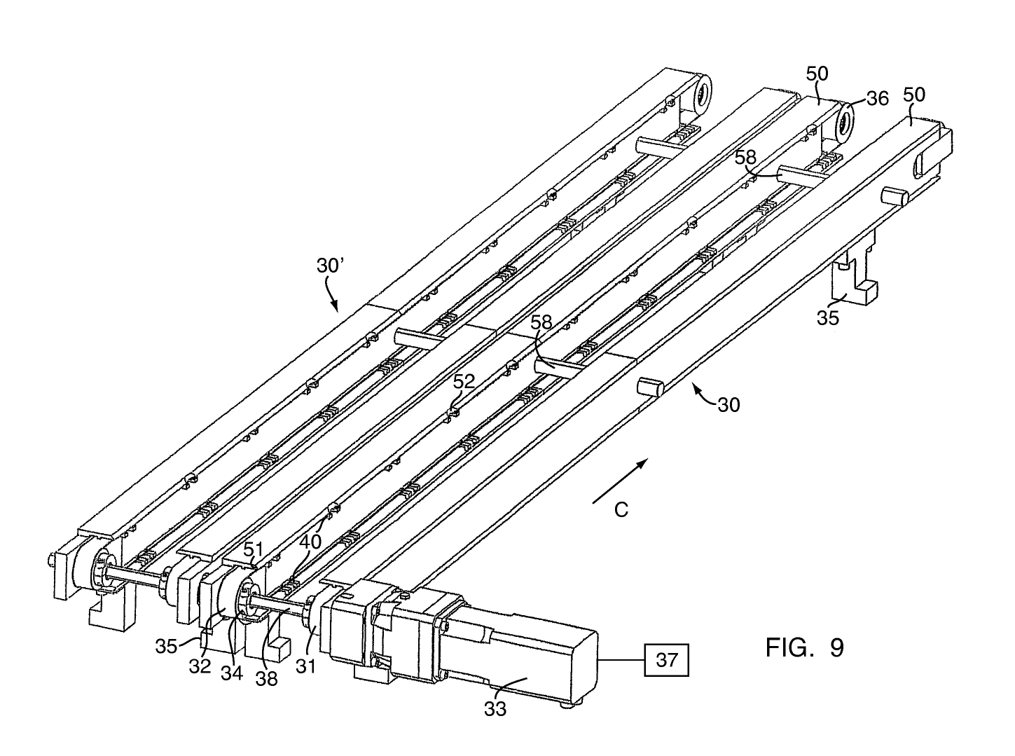

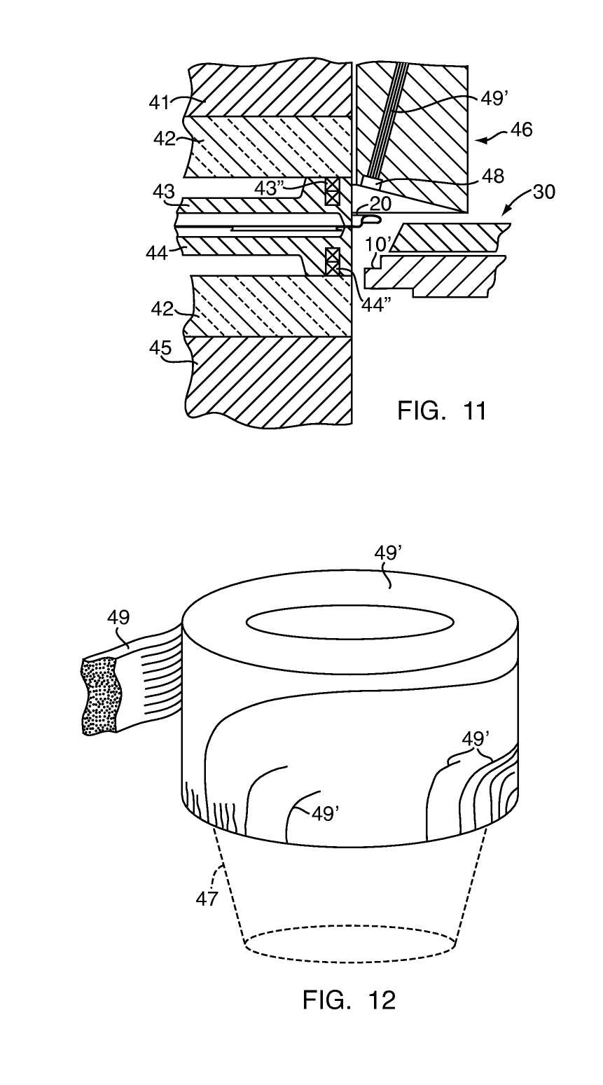

FIGS. 10 to 12 show an embodiment for taking a thermal view within a sealing station 40. The construction of the sealing station itself can be done in conventional manner and is thus known to the person skilled in the art; accordingly it can be different to the example shown in the drawings with regard to the conventional parts. An upper sealing head 41 is provided with a thermally insulating layer 42 and carries an upper sealing disc 43 with electrical heating windings 43″ which heat the sealing surface 43′ of the sealing disc 43. This is done by a conventional temperature control that provides the selected sealing temperature that is suitable for the tear-off foil used in the manufacturing process of the objects. In the example shown the upper sealing head is a stationary head. The lower sealing head 45 is movable upwardly and downwardly to provide the closing distance and the opening distance d, respectively. This head 45 carries the lower sealing disc 44, separated by another thermal insulating layer 42, said disc 44 being provided with electrical heating windings 44″ and with the sealing surface 44′. This sealing station 40 is shown in FIG. 10 only partly and without its driving means for opening and closing of the tools since the construction of such a sealing station is well known to the skilled person and doesn't need detailing here. As well only partly shown is a cover or lid 20, respectively, which rests on a conveying means 30 which for example is one of a conveying means explained above with reference to FIG. 1 and FIG. 9. FIG. 10 shows sealing station 40 with the upper sealing tool 43, 43′ and 43″ and the lower sealing tool 44, 44′ and 44′ in its open position in which the annular cover or lid 20, respectively, rests on the conveying means. Further, a position is shown by FIG. 10 in which the sealing step has already taken place and in which a thermographic image of the sealed seam is taken with an imaging means before the cover is moved (perpendicular to the drawing plane) by conveying means 30 to the next station. FIG. 11 on the other hand shows the closed position of the sealing tools and thus the actual sealing of the seam. The cover 20 has been lifted therein off the rest 10′ of the conveyor by the closing movement of the lower tool and has been brought thereby in working, i.e. sealing position. After the sealing by the heated sealing discs the tool is opened again, so that the open position of FIG. 10 is taken. An embodiment is now described that views the sealed seam in this open position of the tools by a thermosensitive or heat sensitive viewing means in the sealing station, so that a thermographic or heat image is generated or recorded, respectively.

To this end light guiding means 49, 49′ are provided in this example. A camera 60 (shown only schematically as a box) views the whole area of the sealed seam of cover 20 through these light guiding means while the sealing tool is in its open state. An adapter part 46 is arranged at the sealing station which takes up the light guides in such a way that they are “looking” to the hot sealed seam. This is depicted in the FIG. by annularly arranged light guiding parts 49′ which are adapted to the shape of the hot sealed seam of cover 20. At their one free end the light guiding parts take up the heat radiation of the heated seam; an optical device 48 may be provided to focus the radiation to the receiving surface of the light guides. The beam of the radiation viewed is shown with lines and referenced with reference numeral 47. The heat radiation or infrared radiation, respectively, emitted by the hot seam is thus received by the light guiding means 49′ so that the radiation from the whole seam is received at the same time. The other free end 49 of the light guiding means at which the radiation viewed is emitted again is arranged so that it can be received by camera 60 which is an infrared sensitive camera as available on the market. This camera therefore takes in this embodiment a single picture which shows the whole hot sealed seam taken up in the infrared range. This picture is then analysed in an analysing means 61, usually a computer running image analysis software, as will be explained below. Light guiding means, such as optical fibres, are generally known and need not be explained here in greater detail. As mentioned already above cameras for taking thermographic images or infrared images, respectively, are known as well.

The light guiding means 49, 49′ can be constructed in different ways known to the person skilled in the art and can be selected as suitable for the special construction of the heat sealing station and its function. FIG. 12 shows an embodiment in which the light guiding means is formed by a great number of optical fibres or a great number of optical fibre bundles which are arranged in annular shape as shown so that infrared radiation emitted by the hot seam along its whole circumference enters the light guiding means. The fibres may be wound in a suitable manner so that the radiation emitted by them is thereby emitted at one location in front of the camera. Several hundred up to several thousand optical fibres can be arranged in this way depending on the number of image points that shall be attained for a suitable resolution of the image. The light guiding means can as well be made of a formed single piece light guide or of a few formed light guiding pieces. It is essential in this embodiment that the sealed seam can be viewed by the light guide when the tool is open and its image can be brought to an infrared sensitive camera or to an infrared sensor. The generation of an image can be done as well in such a way that instead of the light guiding means shown a plurality of infrared sensors or infrared thermometers are arranged around the sealing area of the sealing station 40 such that the sealed seam can be viewed directly by said sensors or thermometers when the tool is open. These sensors or thermometers will output an electrical signal that can then be led to the analysing means 61, so that in this way no camera is needed. Such sensors may for example be provided at the location depicted with 48 where beforehand an optical means has been described. The sensors will be arranged annularly around the sealing disc. Infrared sensitive sensors, which may be combined with an optical means as well or which may comprise an optical means, and infrared thermometers are known to the person skilled in the art and readily available on the market and don't need a detailed description here. Such sensors or thermometers, respectively, are operated with an external electrical source or may comprise an internal electrical source and their output signal is led by a plurality of cables to inputs at the adapter 46 or by an electrical bus system directly to the analysis means 61. Such sensors or thermometers, respectively, if provided in sufficient number and distributed around the sealed seam can view the whole heat image of the seam at the same time and their outputs can be stored in one step or sequentially. The evaluation or analysis, respectively, of this view can be done sequentially by interrogating the sensor signals (directly or as stored sensor signals) one after the other. It is as well possible to provide viewing means for the seam, be it with light guides or with sensors, which view the heat image of only a part of the seam and means are then moved along the seam so that the seam is imaged by a succession of heat images.

After the viewing or recording, respectively, of a single or several thermographic or heat images, respectively, as described, the object 20 is moved away by the conveying means and the next object to be treated is placed into the sealing station 40 by the conveying means and is hot sealed therein after closing the tool as shown in FIG. 11; after the sealing step the sealing tool is opened and the seal is viewed or imaged, respectively, as described above.

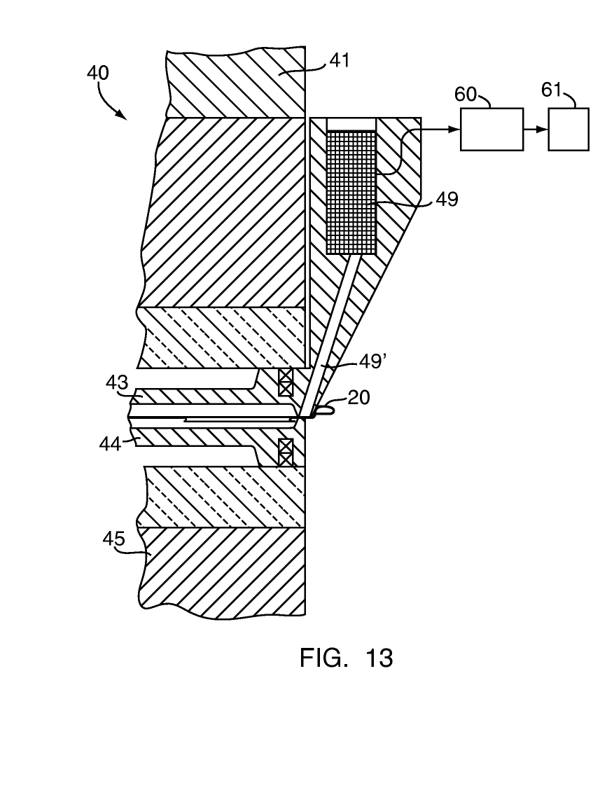

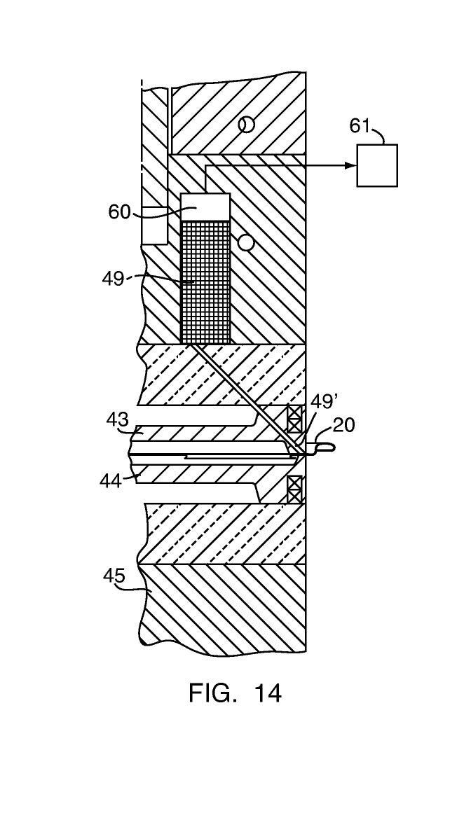

FIGS. 13 and 14 show further embodiments and the same reference numerals depict essentially the same elements as described before. In these embodiments it is possible to view and image the seal even when the sealing tool is closed since the light guiding means 49″ are led into the upper sealing disc 43 which is provided to this end with a large number of through-holes out of which the light guiding means can view the seam even when the tool is closed. The light guiding means can again be provided as single optical fibres or fibre bundles or larger light guiding elements. The fibres and fibre bundles or the elements are then again bundled together at an output location 49, so that an infrared camera or sensor can view the heat image of the sealed seam. In the embodiment of FIG. 13 it is shown that the light guiding means are arranged with their ends facing the camera are placed at the outside of the sealing head and in the embodiment of FIG. 14 the light guiding ends facing the camera are within the sealing head.

The contour of the sealed seam can be round, oval, or rectangular as is known and usually corresponds to the shape of the object or cover, respectively. These contours can be handled with all embodiments shown.

When the heat image of the sealed seam has been provided as described above, be it as a single image, as a sequence of images or as a temperature curve over the length of the seal taken with infrared sensors, it can be detected in a simple manner whether the seam has been correctly sealed or not. This can be done by an evaluation of the image or the images or the temperature curve; by this evaluation of the heat image or the temperature curve it can be detected whether the temperature of the sealed seam is within a predetermined range that is the known correct range for the seam temperature. This range of the correct temperature is known to the person skilled in the art and depends on the used heat sealing materials. A corresponding sealing temperature has to be selected for the sealing tool as is known to the person skilled in the art. Upon evaluation of the image it is possible to analyse the image by known image analysing techniques. Since it has only to be detected whether the section of the view of the seam actually evaluated is too hot or too cold with regard to the correct temperature range, the evaluation can be done by a simple comparison of the imaged temperatures with this correct range. The image can be evaluated for example line by line or as a whole. The image analysis can be done by a computer program suitable for image analysis; such programs are available on the market. If areas of the image or parts of the temperature curve exhibit temperatures that are too hot or temperatures that are too cold in comparison with the correct temperature range, the viewed seam is defective and thus the object or can cover is defective. Such parts of the image are shown in a heat image as parts that are too bright or parts that are too dark what can be detected by a very simple image analysis and is known to the person skilled in the art. Objects or covers or lids, respectively, thus identified as defective are sorted out. This can be done by different exits at the end of the apparatus as has been shown in FIG. 1. It is as well possible to remove defective objects right after the sealing station.

Instead of or in addition to a simple analysis of a viewed temperature or temperature curve with an upper and lower limit it is as well possible, in particular with an image, to provide a more detailed analysis and to try to assign a cause of the defect to the viewed defective parts of the seam. As well it can be detected whether defects are found due to a temperature that is too high or a temperature that is too low, whether the defects occur often or always at the same location of the seam, how large the defective areas of the seam are etc.

A method and an apparatus are thus provided for taking heat images of heat sealed seams. Such seams are made in heat sealing stations and in particular when making covers or lids, respectively, for containers, being provided with a tear-off foil that closes the container up to the first use of its contents. For ascertaining the air-tightness of the heat sealed seam during manufacturing a heat image of the seam is taken while the seam is still hot. By evaluating the image it can be detected whether the temperature of the seam is within a range that assures a correct seam or has exceeded an upper or lower limit for the temperature which is indicative of a defective heat sealed seam. Defective objects can then be discarded based on the evaluation of the heat image. This test of the correctness of the heat sealing is much faster than a pressure differential test testing the actual air tightness of the seam and can thus be used in high speed manufacturing apparatus for covers or lids, respectively.

While there are shown and described presently preferred embodiments of the invention, it is to be distinctly understood that the invention is not limited thereto but may be otherwise variously embodied and practised within the scope of the following claims.

1. A method for the manufacture of objects with a heat-sealed seam which is made during manufacturing in a sealing station, wherein a heat image of said heat sealed seam is viewed in said sealing station or within a neighbouring station to said sealing station and wherein said heat image is evaluated for detecting defective parts of the seam.

2. The method of claim 1 wherein a tear-off foil is heat sealed to a container cover or lid, respectively, within a stationary sealing station.

3. The method of claim 1 wherein the heat image is taken while the sealing tools of said sealing station are in an open state.

4. The method of claim 1 wherein the heat image is taken through a sealing disc of a sealing tool of said sealing station while said sealing tool is closed.

5. The method of claim 1 wherein the whole seam is viewed in one image.

6. The method of claim 1 wherein said seam is viewed by taking several images of parts of said seam.

7. The method of claim 6 wherein the several images are taken at the same time with several stationary imaging means.

8. The method of claim 6 wherein the several images are taken one after another with movable imaging means.

9. The method according to claim 1 wherein the image is taken by a plurality of light guiding fibres which are mounted so that their input ends follow the shape of said seam and their output ends are bundled together and a infrared sensitive camera takes the view of said seam by looking at said output ends.

10. The method of claim 1 wherein the image is taken by a plurality of infrared sensors or infrared thermometers, respectively, which are arranged to look at said seam.

11. The method according to claim 1 wherein the image is evaluated by image analysis means comprising an analysing software for detecting spots in the image that are too bright or too dark compared with the other parts of the image of the seam.

12. An apparatus for the manufacture of objects with heat sealed seams comprising a conveyor means for said objects and a plurality of stationary working stations for said objects arranged along said conveyor means and including a heat sealing station, wherein means for viewing a heat image or heat curve of said seam are provided in or on said sealing station or in or on a working station downstream of said sealing station and analysing means for said heat image or heat curve are connected to said viewing means.

13. The apparatus of claim 12 wherein said means for viewing said heat image are provided for viewing said image during the open state of a sealing tool of said sealing station.

14. The apparatus of claim 12 wherein said means for viewing said heat image are provided for viewing said image during the closed state of a sealing tool of said sealing station and said viewing means comprise a plurality of light guides reaching into through-holes of one of the sealing discs of said sealing tool.

15. A method for the manufacture of container cover or lids, respectively, with a heat-sealed tear-off foil attached on said cover or lid, respectively, in a stationary sealing station, comprising the steps of viewing a heat image of said heat sealed seam while said cover or lid, respectively, is located in said sealing station and while the sealing tools of said sealing station are in an open state after sealing, evaluating said heat image for detecting defective parts of the seam, and discarding covers or lids, respectively, depending on the analysed temperature of the seam in said viewed image during evaluation.

16. A method for the manufacture of container cover or lids, respectively, with a heat-sealed tear-off foil attached on said cover or lid, respectively, in a stationary sealing station, comprising the steps of viewing a heat image of said heat sealed seam while said cover or lid, respectively, is located in said sealing station and while the sealing tools of said sealing station are in a closed state during or after sealing, evaluating said heat image for detecting defective parts of the seam, and discarding covers or lids, respectively, depending on the analysed temperature of the seam in said viewed image during evaluation.

17. An apparatus for the manufacture of objects with heat sealed seams comprising a conveyor means for said objects and a plurality of stationary working stations for said objects arranged along said conveyor means and including a heat-sealing station as one of said working stations, wherein light guides and an infrared camera for viewing a heat image or heat curve of said seam are provided in or on said heat-sealing station and analysing means for said heat image or heat curve are connected to said viewing means and wherein said light guides are arranged for viewing said image during the open state of the sealing tool of said sealing station.

18. An apparatus for the manufacture of objects with heat sealed seams comprising a conveyor means for said objects and a plurality of stationary working stations for said objects arranged along said conveyor means and including a heat-sealing station as one of said working stations, wherein light guides and an infrared camera for viewing a heat image or heat curve of said seam are provided in or on said heat-sealing station and analysing means for said heat image or heat curve are connected to said viewing means and wherein said light guides are arranged for viewing said image during the closed state of the sealing tool of said sealing station.
